(19) United States
(12) Patent Application Publication
(10) Pub. No.: US 2004/0076351 A1
(43) Pub. Date: Apr. 22, 2004

(54) Motor having a fluid dynamic bearing with an asymmetric seal

(76) Inventors: Alan Lyndon Grantz, Aptos, CA (US); Lynn Bich-Quy Le, San Jose, CA (US)

Correspondence Address: MOSER, PATTERSON & SHERIDAN LLP/, SEAGATE TECHNOLOGY LLC, 595 SHREWSBURY AVENUE, SUITE 100, SHREWSBURY, NJ, 07702, US

(21) Appl. No.: 10/641,642

(22) Filed: Aug. 14, 2003

Related U.S. Application Data
(60) Provisional application No. 60/403,275, filed on Aug. 14, 2002.

(51) Int. Cl. F16C 32/06

(52) U.S. Cl. 384/119

(57) ABSTRACT

A bearing structure/sealing configuration with asymmetric sealing and fluid recirculation allows the shaft to exit both ends of the spindle hub is used. Asymmetric sealing is used across the bearing section, with recirculation provided to ensure that the asymmetric seal predominates. A centrifugal capillary seal may be used on one end of the motor, while a grooved pumping seal may be used on the opposite end, providing asymmetric sealing.

The design also allows one of the radial bearings to be located very close to the end of the shaft. If the center of gravity of the hub/disc pack is also located near one end of the shaft, the close axial proximity of one of the radial bearings will minimize the tendency of the disc pack to tilt when subjected to side loading. The radial (journal) bearing which is near the center of gravity of the disc pack can be made stiffer (longer, or different diameter) than the other radial bearing.

### CROSS REFERENCE TO RELATED APPLICATIONS

This application claims the priority of U.S. Provisional Application No. 60/403,275, filed Aug. 14, 2002 by Grantz et al. (entitled “Top Cover Attach FDB With Asymmetric Sealing”), which is herein incorporated by reference.

### FIELD OF THE INVENTION

The invention generally relates to electric motors and, more particularly, to electric motors for disk drives having fluid dynamic bearings.

### BACKGROUND OF THE INVENTION

Disk drives are capable of storing large amounts of digital data in a relatively small area. Disk drives store information on one or more recording media, which conventionally take the form of circular storage disks (e.g. media) having a plurality of concentric circular recording tracks. A typical disk drive has one or more disks for storing information. This information is written to and read from the disks using read/write heads mounted on actuator arms that are moved from track to track across the surfaces of the disks by an actuator mechanism.

Generally, the disks are mounted on a spindle that is turned by a spindle motor to pass the surfaces of the disks under the read/write heads. The spindle motor generally includes a shaft mounted on a base plate and a hub, to which the spindle is attached, having a sleeve into which the shaft is inserted. Permanent magnets attached to the hub interact with a stator winding on the base plate to rotate the hub relative to the shaft. In order to facilitate rotation, one or more bearings are usually disposed between the hub and the shaft.

Over the years, storage density has tended to increase, and the size of the storage system has tended to decrease. This trend has lead to greater precision and lower tolerance in the manufacturing and operating of magnetic storage disks. For example, to achieve increased storage densities, the read/write heads must be placed increasingly close to the surface of the storage disk. This proximity requires that the disk rotate substantially in a single plane. A slight wobble or run-out in disk rotation can cause the surface of the disk to contact the read/write heads. This is known as a “crash” and can damage the read/write heads and surface of the storage disk, resulting is loss of data.

From the foregoing discussion, it can be seen that the bearing assembly that supports the storage disk is of critical importance. One bearing design is a fluid dynamic bearing. In a fluid dynamic bearing, a lubricating fluid such as air or liquid provides a bearing surface between a fixed member of the housing and a rotating member of the disk hub. In addition to air, typical lubricants include gas, oil, or other fluids. Fluid dynamic bearings spread the bearing surface over a large surface area, as opposed to a ball bearing assembly, which comprises a series of point interfaces. This bearing surface distribution is desirable because the increased bearing surface reduces wobble or run-out between the rotating and fixed members. Further, the use of fluid in the interface area imparts damping effects to the bearing, which helps to reduce non-repeat run-out. Thus, fluid dynamic bearings are an advantageous bearing system.

However, as the size, height, and power consumption of fluid dynamic bearing motors is decreased, several problems become more prominent. For one, reducing the size of the motor features, which is a preferred approach to reducing power consumption, tends to cause a decrease in structural stiffness in the bearings as well. This is particularly a problem in current motor designs where structural stiffness is inherently limited due to the fact that the bearings attach only to the base plate of the disk drive. As the structural stiffness decreases, so does the system's tolerance to external vibrations. It is well known in the art that attaching the bearing system to the top cover plate as well as the base plate will increase structural stiffness without increasing bearing power; however, the lack of a suitable sealing system for such a design has made effective implementation difficult.

Therefore, a need exists for a functional fluid dynamic bearing design that accommodates current size, height, and power consumption demands without compromising the structural integrity or functionality of the bearings.

### SUMMARY OF THE INVENTION

A bearing structure/sealing configuration with asymmetric sealing and fluid recirculation is defined.

A compact sealing system which allows the shaft to exit both ends of the spindle hub is used. Asymmetric sealing is used across the bearing section, with recirculation provided to ensure that the asymmetric seal predominates. One way of accomplishing this, is to use a centrifugal capillary seal on one end of the motor, while a grooved pumping seal is used on the opposite end, providing asymmetric sealing.

The design also allows one of the radial bearings to be located very close to the end of the shaft. If the center of gravity of the hub/disc pack is also located near one end of the shaft, the close axial proximity of one of the radial bearings will minimize the tendency of the disc pack to tilt when subjected to side loading. The radial (journal) bearing which is near the center of gravity of the disc pack can be made stiffer (longer, or different diameter) than the other radial bearing. The ability to optimize the bearings in this way, will minimize undesirable disc motion, while also minimizing power consumption—resulting in a more efficient design.

The embodiments herein typically include a bearing structure with both shaft ends exposed. A recirculation path is provided extending partly or wholly around the bearing structure. The ends are sealed by providing a high stiffness, low volume seal (HSLV) at one shaft end and a low volume, high stiffness seal 522 (LSHV) at the other shaft end.

Re-circulation ensures that asymmetric sealing always predominates. The pressure potential of the HSLV seal should always be greater than the end pressure capability of the bearing structure, called the Asymmetric Balance Point (ABP).

The re-circulation path is preferred to be from the LSHV seal, through the FDB structure, to the ABP, then returned to the LSHV. This ensures the LSHV seal is at the lowest pressure in the re-circulation loop. The FDB structure is serving as a pump to suck fluid away from the LSHV seal (which serves as a reservoir) before returning it thru the recirculation path.

Recirculation is analogous to providing a short circuit, or very low resistance, high current capacity, shunt across a battery with relatively high internal resistance as shown in FIG. 6. The effect is to make the voltage appearing across the terminals drop to near zero. In the FDB, the very narrow gaps provide a high resistance to fluid flow (analogous to the high current resistance in a small battery). The much lower flow resistance of the re-circulation path effectively provides a short circuit across the axial pressure generating section of the FDB. In FIG. 6, ^{P}seal=^{P}axial, ^{R}recirc/^{R}pump=PABP; ^{R}recirc/^{R}pump 1500; ^{P}axial=axial pumping pressure of FDB.

Arranging the ABP 525 close to the region of asymmetry, minimizes the effects of axial pumping imbalance in the FDB region. Any FDB region on the non re-circulation side of the ABP 525 should be matched with the asymmetric pump to ensure asymmetric pumping towards the LSHV seal 522.

Applying these principles to the embodiments shown above, referring to FIG. 7, a design similar in concept to FIG. 3B is shown including bearing structure 700 supporting shaft 702 with exposed ends 704, 706. The bearing structure includes single-sided thrust bearing 710; therefore some external preload 712 is utilized. The ends are sealed by a HSLV seal 720 (in this instance a grooved-pumping seal) adjacent the ABP 730 and a LSHV seal 735 (in this example a centrifugal capillary seal) near the thrust bearing 710. A full recirculation path 740 extends from thrust bearing 710 to the ABP 730, supporting clockwise circulation.

FIG. 8 is a design embodying concepts which appear for example in FIG. 4. Bearing structure 800 includes thrust bearing 802 to support shaft 804 with fixed, exposed ends 810, 812. In this instance partial recirculation path 820 is utilized extending to an ABP point partway axially through the two-section journal bearing 830, 832 from thrust bearing 802. Sealing is provided by an HSLV seal 840 (a grooved pumping seal based on journal bearing 830 asymmetric grooving) distal from the thrust bearing, and a LSHV seal (in this example a centrifugal capillary seal) near the thrust bearing 802.

In other embodiments, the sealing asymmetry can be provided by a grooved pumping seal (GP) versus a centrifugal capillary seal (CCS), a GPS versus a conventional capillary seal, differential capillary seals, differential GPS or the like.

The grooved pumping seal can be established as a part of the journal bearing nearer the top cover. The purpose of the recirculation path is to minimize the effects of bearing induced pressure on the seals at either end of the shaft, as well as facilitate purging air from the fluid, typically through the LSHV seal.

While the foregoing is directed to embodiments of the invention, other and further embodiments of the invention may be devised without department from the basic scope thereof, and the scope thereof is determined by the claims that follow.

### BRIEF DESCRIPTION OF THE DRAWINGS

So that the manner in which the above recited embodiments of the invention are attained and can be understood in detail, a more particular description of the invention, briefly summarized above, may be had by reference t the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a plan view of one embodiment of a disk drive that comprises a motor in which the invention is used;

FIG. 2 depicts one embodiment of the invention;

FIG. 3 depicts a partial cross-sectional view of second embodiment of a fluid dynamic bearing motor according to the present invention; and

FIG. 4 depicts a partial cross-sectional view of third embodiment of a fluid dynamic bearing motor according to the present invention.

FIGS. 5-8 are schematic diagrams useful in illustrating the operating principles of the invention.

### DETAILED DESCRIPTION

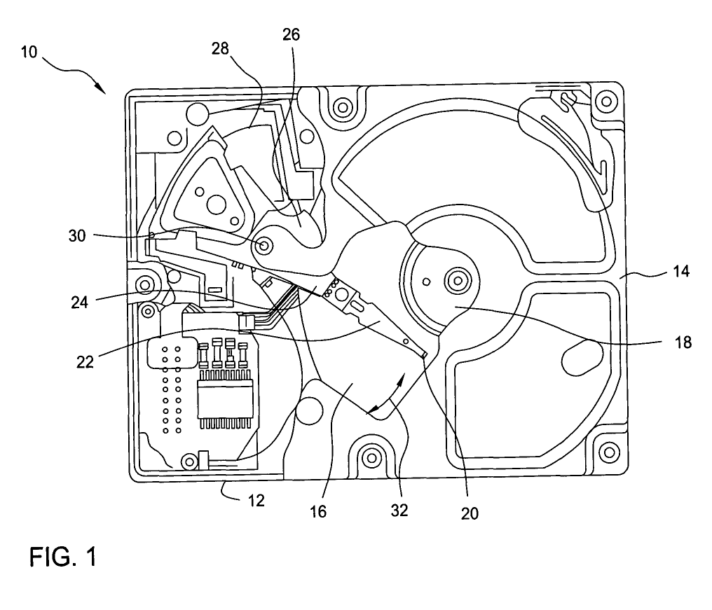

FIG. 1 depicts a plan view of one embodiment of a disk drive 10 for use with embodiments of the invention. Referring to FIG. 1, the disk drive 10 includes a housing base 12 and a top cover plate 14. The housing base 12 is combined with cover plate 14 to form a sealed environment to protect the internal components from contamination by elements outside the sealed environment. The base and cover plate arrangement shown in FIG. 1 is well known in the industry; however, other arrangements of the housing components have frequently been used, and aspects of the invention are not limited by the particular configuration of the disk drive housing.

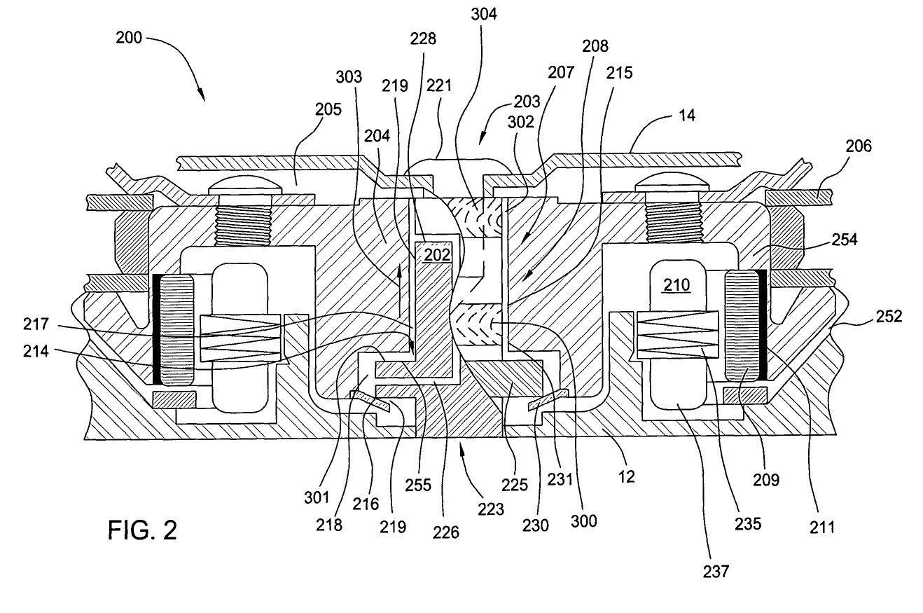

Disk drive 10 further includes a disk pack 16 that is mounted on a hub 202 (see FIG. 2) for rotation on a spindle motor (not shown) by a disk clamp 18. Disk pack 16 includes one or more of individual disks that are mounted for co-rotation about a central axis. Each disk surface has an associated read/write head 20 that is mounted to the disk drive 10 for communicating with the disk surface. In the example shown in FIG. 1, read/write heads 20 are supported by flexures 22 that are in turn attached to head mounting arms 24 of an actuator 26. The actuator shown in FIG. 1 is of the type known as a rotary moving coil actuator and includes a voice coil motor (VCM), shown generally at 28. Voice coil motor 28 rotates actuator 26 with its attached read/write heads 20 about a pivot shaft 30 to position read/write heads 20 over a desired data track along a path 32.

FIG. 2 is a sectional side view of a fluid dynamic bearing motor 200 according to one embodiment of the present invention. The motor 200 comprises a rotating assembly 205, a stationary assembly 203, and a bearing assembly 207.

The rotating assembly 205 comprises a hub 204 that supports at least one disk 206 for rotation and a sleeve 208 affixed to the hub that supports a magnet assembly 252 comprising a back iron 211 with a magnet 209 affixed thereon (although the back iron may be eliminated in many embodiments). In one embodiment of the invention, the magnet assembly 252 is positioned on the inside circumferential surface 254 of the hub 204.

The stationary assembly 203 comprises a shaft 202 mounted on the base 12. The shaft 202 is disposed axially through a bore 231 in the sleeve 208 and supports the hub 204 for rotation. The shaft 202 comprises a first end 221 fixed to the cover plate 14 of the motor 200. The shaft 202 could be fixed to the cover plate 14, for example, by providing a threaded hole in the first end of the shaft and screwing the cover plate 14 into place. A second end 223 of the shaft 202 is fixed to the base 12 and may be similarly screwed into place. The second end 223 also supports a circular thrust plate 225 affixed, for example by press fitting or forming, onto the shaft 202. An annular plenum 218 separates the thrust plate 225 from the sleeve 208. A stator 210 mounted on the base 12 cooperates with the magnet 209 in the hub 204 to induce rotation of the hub 204 relative to the shaft 202. The stator 210 comprises a plurality of “teeth” 235 formed of a magnetic material such as steel, where each of the teeth 235 is wound with a winding or wire 237.

The bearing assembly 207 is formed in a journal (or gap) 217 defined between the facing surfaces of the inner diameter 215 of the sleeve 208 and the outer diameter 219 of the shaft 202. A fluid 214 such as air, oil or gas is disposed between the shaft 202 and the sleeve 208. The journal 217 further comprises fluid dynamic grooves 300, 302 formed on one or both of the of the interfacial surfaces 215, 219 (in FIG. 2A, the fluid dynamic grooves 300 are formed on the outer diameter 219 of the shaft 202). In addition, fluid dynamic grooves 301B are formed either on a first surface 255 of the thrust plate 225 or the facing surface of the sleeve to form an active thrust bearing preferably biased toward the journal 217.

The fluid dynamic grooves help to support stable relative rotation of the hub 204 to the shaft 202. As the hub 204 rotates, fluid 214 is pumped by journal grooves 300, 302 with the journal bearing 302 being asymmetric so that fluid is pumped away from the shaft end 221 toward the thrust plate bearing 301. In this way by axially extending the length of the grooved region 302 so that the journal bearing 302 pumps fluid toward the thrust plate, fluid circulation indicated by arrow 303 is achieved. Also a grooved pumping seal 304 at the outer end 221 of shaft 202 is established, providing fluid to support rotation of the hub 204 around shaft 202. Such a grooved pumping seal 304 which can comprise either lengthened legs on journal bearing grooves 302 or a separate set of grooves. The seal both supplies fluid to the bearing system during rotation, and holds the fluid (functioning as a capillary seal) when the system is at rest. This grooved region 304 which serves as the grooved pumping seal may also be coated, in whole or in part, with DLC so that when the region 304 is pumped nearly dry, as may occur, no damaging metal-to-metal contact occurs with a shock.

It should also be noted that it may be advantageous in this design to further lengthen the journal bearing 302 groove region for enhanced radial stiffness. This allows the disc pack 206 to be located in axial proximity to the shaft end, reducing overall height while minimizing the tendency of the disc pack to tilt when subjected to side loading.

The thrust bearing grooves 301 pump fluid, toward the journal bearing and arrow 303; the effective pumping force of the thrust bearing grooves 301 chances [increasing] as the thrust gap changes. This is balanced by biasing the hub 204 against the thrust bearing with a constant force generated by a magnetic circuit, which in FIG. 2 is accomplished by offsetting the magnet 209 relative to the stator 210. However, the same could be accomplished by establishing an attraction circuit between the base 12 and the hub 204 or sleeve 208 using additional magnets. The magnetic force, used in conjunction with a thrust plate 225 grooved on only one surface 255 results in reduced power consumption as compared to prior art designs that utilize a thrust plate with two grooved surfaces.

The journal pumping grooves 302 are located proximate the first end 221 of the shaft 202 and pump fluid 214 through a plenum 228 disposed through interior portion of the shaft 202 that connects to a fluid re-circulation path 226 defined through the center of the shaft 202. The plenum 228 depicted in FIG. 2 is disposed between the journal grooves 302 and the journal fluid dynamic grooves 300, but it is to be appreciated that the plenum 228 and re-circulation path 226 may also be used where the grooves 302 simply comprise asymmetric extensions of the journal fluid dynamic grooves (i.e. one set of asymmetric grooves); the plenum entry port is simply located proximate the shorter leg of the groove pattern so that fluid is pumped into it.

The fluid re-circulation path 226 returns fluid 214 to a centrifugal capillary seal 216 preferably defined at the second end 223 of the shaft 202, where the pressure gradients in the fluid 214 force bubbles out the re-circulation path 226 and into the capillary seal 216. Specifically, the capillary seal 216 is defined between the thrust plate 225 and a rotating shield 230 supported from the sleeve 208, and the diverging surfaces retain fluid 214 by means of meniscus 219 surface tension, or by centrifugal force when the motor 200 rotates. The capillary seal 216 also functions as a fluid reservoir for the bearing assembly 207; that is, when the motor 200 is spun down, fluid 214 is returned from the capillary seal 216 to the volume occupied by the pumping grooves 302. When the motor starts up, the grooved pumping seal pumps fluid toward the reservoir.

The fluid re-circulation path 226 also ensures that the pressure due to asymmetry of the journal grooves and to the inward pumping from the thrust bearing grooves 301 is reduced to essentially atmospheric pressure. The flow resistance of the re-circulation path 226 is significantly lower than that of the journal grooves, so all pressure drops occur across the journal 217. The recirculation described above is also important for eliminating air bubbles from the fluid. As the fluid circulates, the bubbles are entrained in the fluid; the bubbles are carried by the pressure differentials established to the capillary seal, and exit the system through the meniscus 219.

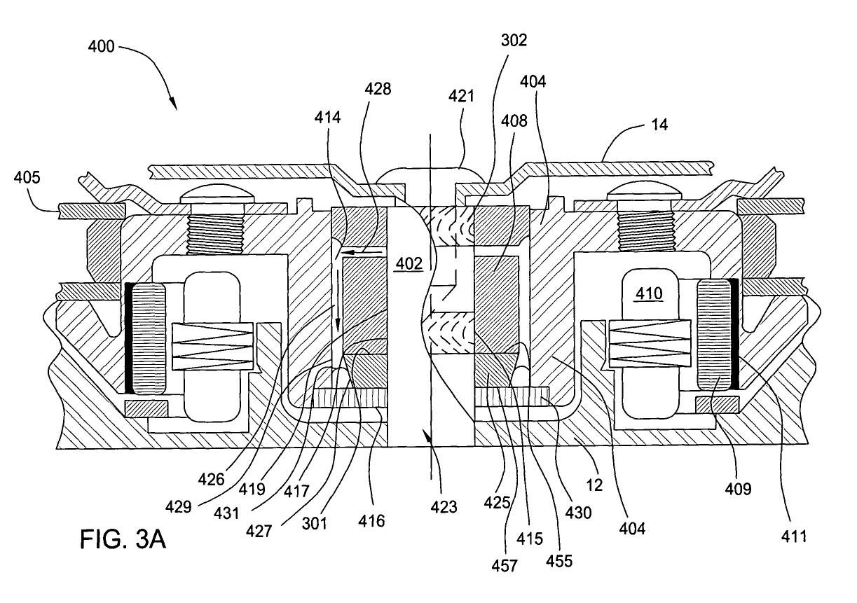

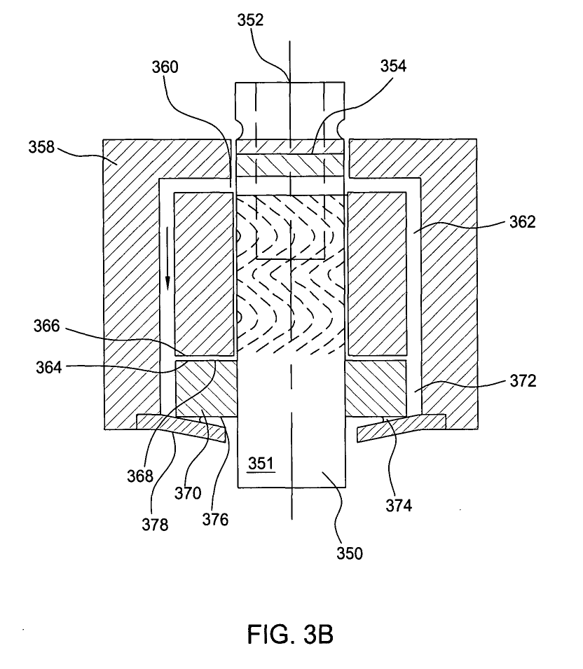

An alternate embodiment of a fluid dynamic bearing motor 400 is shown in FIG. 3A. The motor 400 functions much like the motor 200 in FIG. 2. As in the previous embodiment, the motor 400 comprises a shaft 402 attached at a first end 421 to a cover plate 14 and supporting a circular thrust plate 425 at a second end 423. The shaft 402 supports a hub 404 for rotation. The hub further comprises a back iron 411 with a magnet 409 affixed thereon that cooperates with a stator 409 (mounted to the base 12) to induce rotation of the hub.

A journal 417 is defined between the facing surfaces of an outer diameter 419 of the shaft 402 and an inner diameter 415 of the hub's sleeve 408. The journal comprises fluid dynamic grooves 300 302 formed on at least one of the interfacial surfaces 415, 419. The grooves 302 are asymmetric to pump fluid through recirculation path 426 on start-up, and to provide a grooved pumping seal to prevent fluid loss from the system. Fluid dynamic grooves 301 are also formed on a first surface 455 of the thrust plate 425 that faces the journal 417. These grooves pump fluid inward toward the journal to aid in fluid circulation.

The fluid dynamic grooves 300 302 on the journal 417 support stable rotation of the hub 404 relative to the shaft 402. The grooves 302 are preferably extended axially to provide stable support for the radially adjacent disc pack 405. The asymmetric journal grooves 302 pump fluid 414 toward a plenum 428 that connects the journal 417 to a fluid re-circulation path 426 in the sleeve 408. The fluid re-circulation path in addition to providing fluid to the thrust bearing 301 426 also depicted in FIG. 3A runs parallel to the shaft 402. The fluid re-circulation path 426 returns fluid 414 to a seal 416 defined between a radial surface 427 of the thrust plate and a facing surface 429 of the sleeve 404. One of the surfaces diverges from the other to define a capillary seal, establishing a meniscus 431 which prevents fluid loss from the system. Further, because of the recirculation, air bubbles in the fluid are purged, exiting the system through the meniscus 431. A seal 416 depicted in FIG. 3 is an exclusion seal a defined between shield 430 supported from hub 404 and surface 433 of thrust plate 425. The gap between the surfaces is very small e.g. about 30 microns, so that little fluid can be lost. The exclusion seal in this embodiment functions as a back-up seal, so that if any fluid splashes onto it, the fluid is trapped. As the shield spins, the fluid is thrown back into the system. The shield 430 also functions as a travel limiter for the hub 404. The shield 430 extends from the hub 404 below the thrust plate 425; thus, when contact is made between a second surface 457 of the thrust plate 425 and the shield 430, the hub 404 is prevented from traveling axially toward the cover plate 14.

FIG. 3B shows a further alternative embodiment combining elements of the rotating recirculation path (i.e. a recirculation path in the sleeve 358) shown in FIG. 3A and the centrifugal capillary seal shown in FIG. 2. That is, referring now to FIG. 3B, the shaft 350 is a fixed shaft to be supported at the base by the extended portion 351 and with a tapped hole or similar feature 352 at the opposite end of the shaft for attachment by a screw or other known means to the top cover of the disc drive.

As with the previous design, a groove pumping seal 354 defined by grooves on either the outer surface of the shaft or the facing surface of the sleeve near the end of the shaft closer to the top cover [are defined to] pumps fluid toward the base end of the system when the sleeve 358 rotates. As with FIG. 3A, an annular plenum 360 is defined through the sleeve, coupling the region adjacent the journal bearings to the rotating recirculation path 362. This recirculation path couples fluid to the thrust bearing 364 defined by facing surfaces 366 on the sleeve and surface 368 on the thrust plate 370 supported from the shaft.

A further annular plenum 372 couples the fluid circulation in part to the centrifugal capillary seal 374 defined between the second axial surface 376 of thrust plate 370 and a facing shield 378 supported from and rotating with the sleeve 358 but at an angle to the surface 376 of the thrust plate 370 to establish a meniscus within the seal which will prevent the loss of any fluid through the base of the circulating system. As previously discussed, some of the fluid in the system will reside in the grooved pumping seal 354 (a low volume, high pressure seal) when the system is at rest. When the sleeve rotates, the fluid is pumped out of the grooved pumping seal, through the fluid recirculation path 362 and, in part, into the lower capillary seal 374 (a high volume, low pressure seal). The fluid is also pumped by thrust bearing 364 toward the journal bearing to enforce fluid circulation. The system purges air bubbles through capillary seal 374 as explained above. Both the embodiments of FIGS. 3A & 3B may comprise 2 section sleeves to facilitate defining the recirculation path through the sleeve.

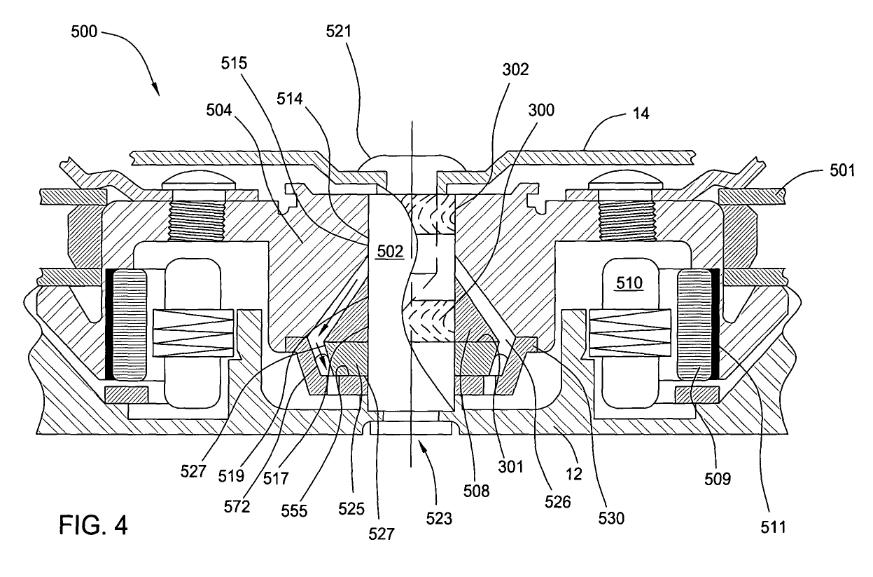

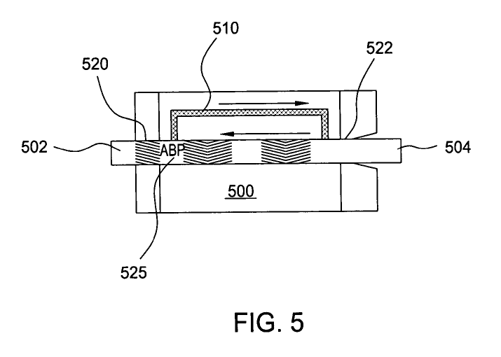

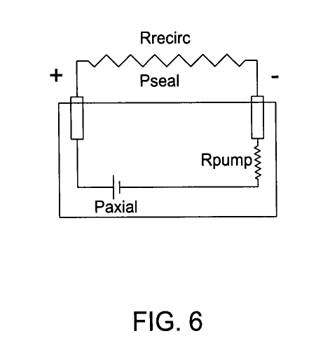

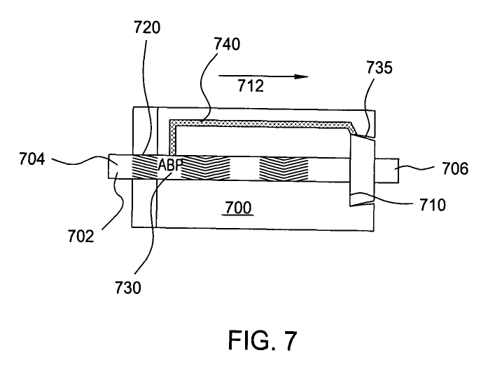

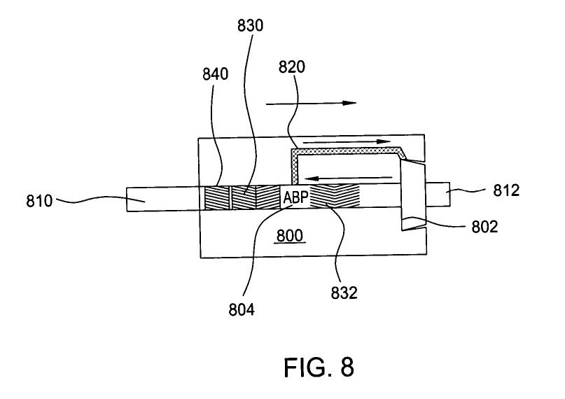

A further embodiment of a fluid dynamic bearing motor 500 is shown in FIG. 4. The motor 500 functions much like the motors 200 and 400 in the previous embodiments. The motor 500 comprises a shaft 502 attached at a first end 521 to a cover plate 14 and supporting a circular thrust plate 525 at a second end 523. The shaft 402 supports a hub 504 for rotation. The hub further comprises a back iron 511 with a magnet 509 affixed thereon that cooperates with a stator 509 (mounted to the base 12) to induce rotation of the hub.

A journal 517 is defined between the facing surfaces of an outer diameter 519 of the shaft 502 and an inner diameter 515 of the hub's sleeve 508. The journal comprises the fluid dynamic grooves 300 and the grooves 302 which function as both a journal bearing (being generally aligned with the disc pack) and a grooved pumping seal (the grooves being preferably asymmetrical to pump toward the base). Fluid dynamic grooves 301 are also formed preferably on a first surface 555 of the thrust plate 525 that faces the journal 517 to pump fluid toward the journal.

The fluid dynamic grooves 300 on the journal 517 support stable rotation of the hub 504 relative to the shaft 502. The grooves define a journal bearing aligned with the center of gravity of discs 501; the asymmetric portion thereof serves as a grooved pumping seal (the GPS seal grooves may also be separated from journal 302); the seal grooves 302 pump fluid 514 toward a fluid re-circulation path 526 in the sleeve 508. The fluid re-circulation path 526 depicted in FIG. 4 is angled, enabling the hub 504 to be manufactured in one piece since it is not bisected by both the plenum and the re-circulation path. The fluid circulation is through the thrust bearing and the journal bearing 300; pressures are achieved to keep fluid in journal bearing 302 and flowing through the recirculation path. The high pressure grooved pumping seal prevents fluid loss at the top of the system.

The fluid re-circulation path 526 returns fluid 514 to a seal 516 defined between a second surface 527 of the thrust plate and a formed rotating shield 530 supported from the hub 504. A centrifugal capillary seal 568 defined between a radial surface 570 of thrust plate 525 and a facing surface 572 of shield 530. These surfaces 570, 572 are at an angle to each other so that a meniscus 575 is formed; preferably these surfaces are both also at an angle to the axis of the shaft to establish a centrifugal force acting on the fluid. This seal 568 also serves as a reservoir. As a secondary or backup seal, an exclusion seal 516 is provided, also serves as an axial travel limiter for the hub 504. The rotating shield 530 is angled and extends below the thrust plate 525, where the shield 530 and thrust plate 525 overlap. Therefore, contact between the thrust plate 525 and the shield 530 prevents the hub 504 from traveling axially toward the cover plate 14. The small gap serves as a backup seal.

The present invention represents a significant advancement in the field of fluid dynamic bearings and fluid dynamic bearing motors. Feature size is reduced to lower power consumption, and the loss of structural stiffness that is normally produced by reduced feature size is mitigated by attaching the shaft to both the base and the cover plate. Utilizing fluid dynamic grooves on one side of the thrust plate rather than both, and combining this with a magnetic force circuit to bias the hub also reduces power consumption. Asymmetric sealing also reduces power consumption and allows for re-circulation of fluid around the journal bearings. Furthermore, the all or part of the shaft may be coated with diamond-like carbon (DLC) to limit wear of features and particle generation resulting from rotation of the hub on the shaft, extending the useful life of the motor. Therefore, structural integrity is enhanced over prior designs, while feature size is reduced so that the motor consumes substantially less power.

In the claims:

1. A disc drive motor comprising:
a shaft having a first end and a second end, where the second end is supported from a base;
a hub rotatably supported on the shaft and including a sleeve through which the shaft is axially disposed;
a fluid journal bearing between an outer diameter of the shaft and an inner diameter of the hub, having an asymmetric seal;
a cover plate affixed to the first end of the shaft; and
a thrust plate supported proximate the second end of the shaft;
wherein the asymmetric seal comprises a grooved pumping seal near the first end of the shaft and a capillary seal near the second end of the shaft, and a fluid recirculation path extending between the grooved pumping seal and the capillary seal.

2. A disc drive motor as claimed in claim 1 including a thrust plate near the second end of the shaft and having a first axial surface facing an axial surface of the sleeve across a gap, the gap being fluidly coupled to a gap of the journal bearing.

3. A disc drive motor as claimed in claim 2 further comprising an annular plenum defined between a radial end surface of the thrust plate and a facing surface of the sleeve, the annular plenum being fluidly connected to the thrust plate gap, the journal bearing gap and a gap of the grooved pumping seal.

4. A disc motor drive motor as claimed in claim 3 wherein the groove pumping seal comprises grooves on one of these surfaces of the shaft or sleeve, the grooves being defined to pump fluid toward the capillary seal at the second end of the shaft.

5. A disc drive motor as claimed in claim 4 wherein the capillary seal is defined between a second axial surface of the thrust plate and a shield supported from the sleeve adjacent the annular plenum.

6. A disc drive motor as claimed in claim 5 wherein the shield includes a generally axial surface at an angle to the second surface of the thrust plate, the shield rotating with the sleeve relative to the second thrust plate surface to define a centrifugal capillary seal coupled to the annular plenum.

7. A disc drive motor as claimed in claim 6 wherein the thrust bearing pumps fluid inward toward the axis of the shaft, and the journal bearing pumps fluid toward the grooved pumping seal.

8. A disc drive motor as claimed in claim 7 wherein the fluid recirculation path extends between an exit point in the fluid dynamic bearing gap between an end of the journal bearing and the grooved pumping seal, and an entry point in the radial surface of the thrust plate.

9. A disc drive motor as claimed in claim 8 further comprising a magnetic bias established between the sleeve and the shaft, but the bias being axially directed to offset any axial influence on the location of the hub due to the asymmetric seal and journal bearing.

10. A disc drive motor as claimed in claim 3 wherein the fluid recirculation path extends from an opening intermediate the journal bearing and the grooved pumping seal through an annular plenum extending partially radially through the sleeve, and fluidly coupled to a one or more fluid recirculation channels extending to a radial surface of the thrust plate and a facing surface of the rotating sleeve.

11. A disc drive motor as claimed in claim 10 wherein the thrust bearing pumps inwardly toward the journal bearing, and the journal bearing pumps away from the thrust bearing toward the grooved pumping seal, with fluid circulation being maintained through the fluid recirculation path defined through the sleeve.

12. A disc drive motor as claimed in claim 11 further comprising a shield extending radially from and supported from the sleeve and extending below an axial second surface of the thrust plate, whereby travel of the sleeve axially relative to the shaft is limited by the facing axial surfaces of the shield and the thrust plate.

13. A disc drive motor as claimed in claim 12 wherein the radial surface of the thrust plate and facing surface of the sleeve define the capillary seal.

14. A disc drive motor as claimed in claim 11 wherein the fluid recirculation path includes an entry port adjacent the end of the journal bearing.

15. A disc drive motor as claimed in claim 11 further comprising an annular plenum defined between a radial end surface of the thrust plate and a facing surface of the sleeve, the annular plenum being fluidly connected to the thrust plate gap, the journal bearing gap and a gap of the grooved pumping seal.

16. A disc motor drive motor as claimed in claim 15 wherein the groove pumping seal comprises grooves on one of these surfaces of the shaft or sleeve, the grooves being defined to pump fluid toward the capillary seal at the second end of the shaft.

17. A disc drive motor as claimed in claim 16 wherein the capillary seal is defined between a second axial surface of the thrust plate and a shield supported from the sleeve adjacent the annular plenum.

18. A disc drive motor as claimed in claim 2 further comprising a single piece sleeve rotating around the shaft and including one or more angled from the journal bearing gap near the groove pumping seal to the capillary seal.

19. A disc drive motor as claimed in claim 18 further comprising a shield extending generally axially past an end surface of the thrust plate and radially toward the shaft so that an axial surface of the shield underlies a second axial surface of the thrust plate, whereby the shield serves as a limiter for relative axial movement of the sleeve and shaft.

20. A disc drive motor as claimed in claim 19 wherein an radial surface of the shield faces a radial surface of the thrust plate and spaced there from, so that the two surfaces define a centrifugal capillary seal fluidly coupled to the fluid recirculation path.

21. A fluid dynamic bearing structure comprising a fixed shaft, a journal bearing comprising fluid in a bore defined by the fixed shaft and a sleeve rotating around the shaft, a high stiffness low volume seal (HSLV) near one end of the shaft and a low stiffness high volume seal near a second end of the shaft to maintain the fluid within the fluid bearing, and a recirculation path extending around the bearing structure from an exit port nearer the low stiffness high volume seal to an entry port nearer the high volume low stiffness seal to support clockwise fluid circulation around the bearing structure.

22. A fluid bearing system as claimed in claim 21 wherein the entry point of the recirculation path is at the asymmetric balance point (ABP) of the fluid circulation path, the pressure potential of the HSLV seal thereby being greater than the end pressure of the journal bearing.

23. A fluid bearing system as claimed in claim 21 wherein the recirculation path is from the LSHV seal through the fluid dynamic journal bearing to the ABP and then return to near the LSHV.

24. A fluid dynamic bearing structure as claimed in claim 23 wherein the LSHV is a capillary seal of sufficient capacity to serve as a reservoir for the fluid bearing system.

25. A fluid dynamic bearing system as claimed in claim 24 wherein the bearing system includes a thrust bearing at an end of the shaft near the LSHV seal.

26. A fluid dynamic bearing system as claimed in claim 25 wherein the recirculation path extends from an entry point at the ABP to an exit port near the thrust bearing.

27. A fluid dynamic bearing system as claimed in claim 26 wherein the ABP is intermediate the journal bearing structure and the HSLV seal.

28. A fluid dynamic bearing system as claimed in claim 27 wherein the fluid dynamic bearing system recirculation path is a partial recirculation path from the thrust bearing to a entry point intermediate the journal bearing.

29. A fluid dynamic bearing system as claimed in claim 28 wherein the journal bearing adjacent the HSLV seal has enough asymmetry to drive fluid toward the ABP.

30. A fluid dynamic bearing system as claimed in claim 29 wherein the HSLV seal is a groove pumping seal established by journal bearing asymmetry and the LSHV seal is a centrifugal capillary seal.
